(19) United States
(12) Patent Application Publication
(10) Pub. No.: US 2024/0177323 A1
(43) Pub. Date: May 30, 2024

(54) APPARATUS, IMAGING APPARATUS, AND METHOD

(71) Applicant: CANON KABUSHIKI KAISHA, Tokyo (JP)

(72) Inventor: HIROYO TANAKA, Kanagawa (JP)

(21) Appl. No.: 18/516,413

(22) Filed: Nov. 21, 2023

(30) Foreign Application Priority Data
Nov. 24, 2022 (JP) 2022-187569

(51) Int. Cl. G06T 7/20; G06T 7/70; G06V 10/25; G06V 10/74; H04N 23/611; H04N 23/68

(52) U.S. Cl. CPC G06T 7/20; G06T 7/70; G06V 10/25; G06V 10/761; H04N 23/611; H04N 23/681; G06T 2207/30196; G06V 2201/07

(57) ABSTRACT

An apparatus comprises an acquisition unit that acquires information about a subject detected from a captured image, a calculation unit that calculates a tracking amount based on a position of the subject in the captured image and a target position, a control unit that controls subject tracking to bring the position of the subject in the captured image close to the target position, based on the tracking amount, and a setting unit that sets first and second regions based on at least any of a holding state of an imaging apparatus that captures the captured image, a detection result of an operation performed by a photographer on the imaging apparatus, a position in the captured image of the target position, and a type of the subject, wherein, in the first region, a degree to which the subject tracking is performed is lower than in the second region.

### BACKGROUND

### Technical Field

The aspect of the embodiments relates to stabilization of a subject image using an image blur correction unit.

### Description of the Related Art

There has been a function of stabilizing blurring in a moving image using an imaging apparatus including an image blur correction unit.

This function is executed by driving an image blur correction unit in such a manner as to cancel out camera shake in accordance with a camera shake signal detected by a detection unit, or changing a position of a region to be extracted from an image capturing region by image processing. The former is called optical camera shake correction and the latter is called electronic camera shake correction.

Meanwhile, when the above-described imaging apparatus including the image blur correction unit records a moving image, a subject sometimes goes out of a frame even with camera shake corrected. This is because, even if camera shake caused by the motion of the imaging apparatus is corrected, the motion of a subject cannot be corrected. For this reason, to prevent a moving subject from going out of the frame, a photographer is to execute framing while paying attention to the motion of the subject.

To solve the above-described issue, an image blur correction apparatus discussed in Japanese Patent Application Laid-Open No. 2017-215350 proposes determining which of subject tracking and camera shake correction is to be executed, depending on an image capturing state.

By employing the above-described configuration, it makes it possible to move the image blur correction unit in accordance with the motion of the subject. It is therefore possible to execute both of subject tracking and camera shake correction.

### SUMMARY

According to an aspect of the embodiments, an apparatus includes one or more processors and a memory coupled to the one or more processors storing instructions that, when executed by the one or more processors, cause the one or more processors to function as: an acquisition unit that acquires information about a subject detected from a captured image, a calculation unit that calculates a tracking amount based on a position of the subject in the captured image and a target position, a control unit that controls subject tracking to bring the position of the subject in the captured image close to the target position, based on the tracking amount, and a setting unit that sets first and second regions based on at least any of a holding state of an imaging apparatus that captures the captured image, a detection result of an operation performed by a photographer on the imaging apparatus, a position in the captured image of the target position, and a type of the subject, wherein, in the first region, a degree to which the subject tracking is performed is lower than in the second region.

Further features of the disclosure will become apparent from the following description of exemplary embodiments with reference to the attached drawings.

### BRIEF DESCRIPTION OF THE DRAWINGS

FIG. 1 is a block diagram illustrating a configuration example of an imaging apparatus according to a first exemplary embodiment.

FIG. 2 is a block diagram illustrating a configuration example of a mechanism related to image blur correction control and subject tracking control according to the first exemplary embodiment.

FIG. 3A is a flowchart illustrating subject tracking according to the first exemplary embodiment.

FIG. 3B is a flowchart illustrating subject tracking region setting according to the first exemplary embodiment.

FIG. 3C is a diagram illustrating a camera work determination timing according to the first exemplary embodiment.

FIG. 4A illustrates a graph indicating an angular speed signal output while a photographer is walking.

FIG. 4B illustrates a graph indicating the angular speed signal output while the photographer is walking.

FIG. 4C illustrates a graph indicating the angular speed signal output while the photographer is walking.

FIGS. 5A and 5C are diagrams illustrating an example of a tracking region and a tracking amount.

FIG. 5B and 5D are diagrams illustrating another example of a tracking region and a tracking amount.

FIG. 6 illustrates a table related to tracking region setting according to second and third exemplary embodiments.

FIG. 7A is a diagram illustrating a tracking region setting example according to the third exemplary embodiment.

FIG. 7B is a diagram illustrating another tracking region setting example according to the third exemplary embodiment.

FIG. 8A is a diagram illustrating a tracking region setting example according to a fourth exemplary embodiment.

FIG. 8B is a diagram illustrating another tracking region setting example according to the fourth exemplary embodiment.

FIG. 9 illustrates a time series graph indicating a subject detected position and a tracking amount.

### DESCRIPTION OF THE EMBODIMENTS

Hereinafter, exemplary embodiments of the disclosure will be described in detail based on the accompanying drawings. The following exemplary embodiments are not intended to limit the disclosure set forth in the appended claims.

A plurality of features are described in each exemplary embodiment, but not all of the plurality of features are essential to the disclosure, and the plurality of features may be arbitrarily combined.

Furthermore, in the accompanying drawings, the same or similar configurations are assigned the same reference numerals, and the redundant description will be omitted.

The image blur correction apparatus discussed in Japanese Patent Application Laid-Open No. 2017-215350 proposes determining which of subject tracking and camera shake correction is to be executed, depending on an image capturing state. Nevertheless, as a result, it has been revealed that a subject sometimes becomes unable to be appropriately tracked, depending on an image capturing situation.

In view of the foregoing, a control apparatus and an imaging apparatus that can appropriately perform subject tracking will be described in the present exemplary embodiment.

In the present exemplary embodiment, the description will be given of an imaging apparatus that determines an imaging apparatus holding state where the imaging apparatus is held by a photographer (camera work determination), using a shake detection unit, and sets a subject tracking region based on the determination result.

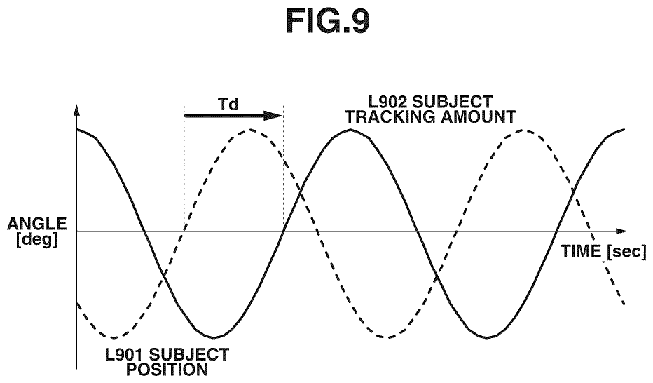

First of all, a case where an unnatural movie is captured if subject tracking is performed under a certain image capturing situation will be described with reference to FIG. 9.

FIG. 9 illustrates a time series graph indicating a subject detected position and a subject tracking amount (hereinafter, will be referred to as a tracking amount) that are obtained when both the stopping of a subject and the stopping a background are not good. In FIG. 9, a vertical axis indicates an angle, and a horizontal axis indicates a time. A dotted line indicates a subject detected position L901, and the subject detected position L901 farther from an axis indicates a position farther from a target position. On the other hand, a solid line indicates a subject tracking amount L902 calculated from the subject detected position L901, and the subject tracking amount L902 farther from the axis indicates a larger tracking amount. That is, the subject tracking amount L902 farther from the axis indicates a larger amount of variation in an image capturing range that is caused by subject tracking control.

As illustrated in FIG. 9, during the process of the calculation of the subject tracking amount, a delay time Td is often generated.

This delay time Td is generated because filter processing or the like is required due to a variation generated among outputs of a subject detection unit, for example. If the delay time Td is generated during the process of tracking amount calculation in this manner, even at a timing at which a subject detected position coincides with a target position, a subject tracking amount does not become 0. In contrast, at a timing at which subject tracking is required, a subject tracking amount becomes 0. This sometimes produces a movie in which both the stopping of a subject and the stopping a background are not good.

Especially under a situation where a photographer firmly holds an imaging apparatus, because a variation in image capturing range that is caused by camera shake is small, the above-described issue is more visible, and a photographer and a viewer of the movie sometimes feel unnaturalness in the movie. In addition, if a photographer is firmly holding an imaging apparatus, the photographer can execute framing in the scene, and it is considered that a subject is unlikely to go out of a frame. Accordingly, in such a scene, the unnaturalness is highly likely to stand out more than the effect of subject tracking in the movie. Thus, in the present exemplary embodiment, a tracking region that is a range in which subject tracking is to be performed is set based on a holding state of an imaging apparatus. In this specification, the image capturing range refers to a range of an image to be captured and recorded. That is, in a case where electronic camera shake correction or crop image capturing is performed, the image capturing range refers to the range of a cropped image.

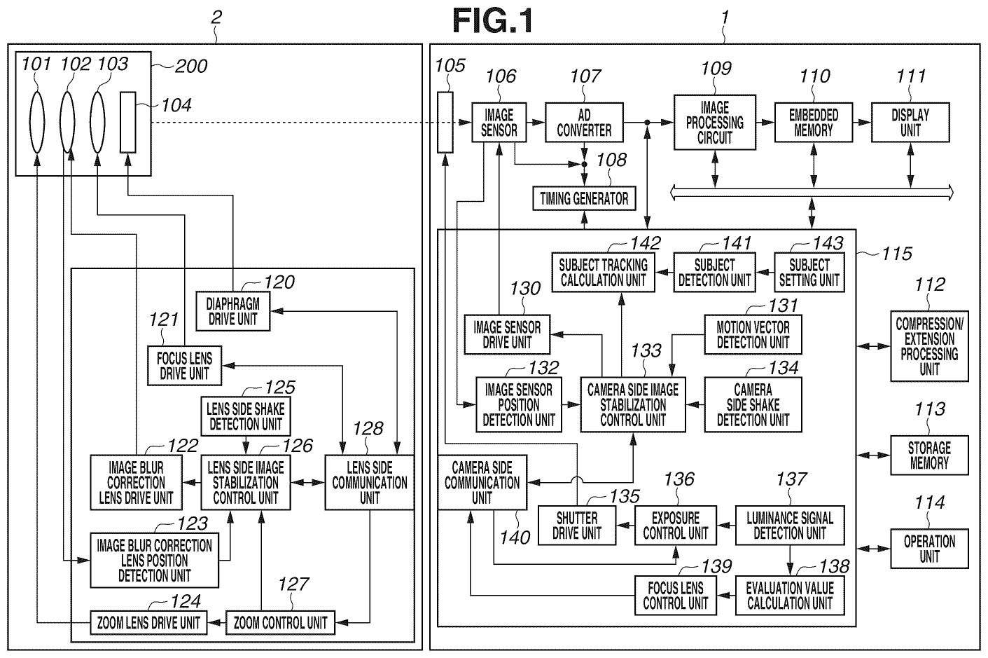

FIG. 1 is a block diagram illustrating a configuration of an imaging apparatus according to the present exemplary embodiment. The imaging apparatus according to the present exemplary embodiment is an interchangeable-lens imaging apparatus, and includes an imaging apparatus main body (hereinafter, camera main body) 1 and a lens apparatus 2 attachable to and detachable from the camera main body 1.

The lens apparatus 2 includes an imaging optical system 200. The imaging optical system 200 includes a zoom lens 101, an image blur correction lens 102, a focus lens 103, and a diaphragm 104.

By moving in an optical axis direction, the zoom lens 101 optically changes a focal length of the imaging optical system (imaging lens) 200 that forms a subject image and changes an image capturing field angle. By moving in a direction vertical to the optical axis, the image blur correction lens 102 optically corrects image blur attributed to the shake of the imaging apparatus. By moving in the optical axis direction, the focus lens 103 optically adjusts a focus position. By opening or closing the diaphragm 104 and a shutter 105, it is possible to adjust a light amount. The diaphragm 104 and the shutter 105 are used for exposure control.

A diaphragm drive unit 120 and a shutter drive unit 135 drive the diaphragm 104 and the shutter 105, respectively. A zoom lens drive unit 124 drives the zoom lens 101 and changes a field angle. A zoom lens control unit 127 performs position control of the zoom lens 101 in accordance with a zoom operation instruction issued via an operation unit 114. The zoom lens 101 may be moved by operating a zoom ring provided around the lens apparatus 2. A focus lens drive unit 121 drives the focus lens 103. Light having passed through the imaging optical system 200 is received by an image sensor 106 that uses a charge-coupled device (CCD) sensor or a complementary metal-oxide semiconductor (CMOS) sensor, and is converted from an optical signal into an electronic signal.

An analog-to-digital (AD) converter 107 performs noise removal processing, gain adjustment processing, and AD conversion processing on an image capturing signal read out from the image sensor 106.

In accordance with a command issued by a camera control unit 115, a timing generator 108 controls a drive timing of the image sensor 106 and an output timing of the AD converter 107. An image processing circuit 109 performs pixel interpolation processing or color conversion processing on an output from the AD converter 107, and then transmits processed image data to an embedded memory 110. The image processing circuit 109 includes an alignment circuit for aligning a plurality of sequentially captured images, a geometric transformation circuit that performs cylindrical coordinate conversion and distortion correction of a lens unit, and a composition circuit that performs trimming and composition processing. In addition, electronic camera shake correction is performed using a projective transformation circuit included in the image processing circuit 109. Because an operation of each circuit is known, the detailed description thereof will be omitted.

A display unit 111 displays image capturing information together with image data stored in the embedded memory 110.

A compression/extension processing unit 112 performs compression processing or extension processing on data stored in the embedded memory 110, in accordance with an image format.

A storage memory 113 stores various types of data such as parameters.

The operation unit 114 is a user interface for a user to perform various image capturing operations, menu operations, and mode switching operations.

The camera control unit 115 includes an arithmetic device such as a central processing unit (CPU) and executes various control programs stored in the embedded memory 110, in accordance with a user operation performed via the operation unit 114. The control programs are programs for performing zoom control, image blur correction control, automatic exposure control, automatic focusing control, and processing of detecting a face of a subject, for example.

In the case of an interchangeable-lens camera, information communication is performed between the camera main body 1 and the lens apparatus 2 using a camera side communication unit 140 and a lens side communication unit 128.

A luminance signal detection unit 137 detects a signal that has been read out from the image sensor 106 in an image capturing preparation state (so-called live view state) and has passed through the AD converter 107, as luminance of a subject and a scene.

An exposure control unit 136 calculates an exposure value (aperture value and shutter speed) based on luminance information obtained by the luminance signal detection unit 137 and notifies the diaphragm drive unit 120 and the shutter drive unit 135 of the calculation result via the camera side communication unit 140 and the lens side communication unit 128. At the same time, the exposure control unit 136 also performs control of amplifying the image capturing signal read out from the image sensor 106. Automatic exposure control (AE control) is thereby performed.

An evaluation value calculation unit 138 extracts a specific frequency component from the luminance information obtained by the luminance signal detection unit 137, and then calculates a contrast evaluation value based on the extracted specific frequency component.

A focus lens control unit 139 issues a command to the focus lens drive unit 121 via the camera side communication unit 140 and the lens side communication unit 128 to drive the focus lens 103 with a predetermined drive amount over a predetermined range. At the same time, the focus lens control unit 139 acquires an evaluation value at each focus lens position as a result of calculation by the evaluation value calculation unit 138. The focus lens control unit 139 thereby calculates an in-focus position in a contrast autofocus (AF) method from a focus lens position at which a change curve of a contrast evaluation value reaches a peak, and transmits the calculated in-focus position to the focus lens drive unit 121. The focus lens 103 is driven by the focus lens drive unit 121 based on the received in-focus position, so that autofocus control (AF control) of focusing light beams onto the surface of the image sensor 106 is performed.

In this example, the contrast AF method has been described, but an AF method is not specifically limited, and may be a phase difference AF method, for example. Because the details of the phase difference AF method are known, the description thereof will be omitted.

A lens side shake detection unit 125 and a camera side shake detection unit 134 detect shake and vibration added to the imaging apparatus. In the present exemplary embodiment, the respective shake detection units are arranged on the camera side and the lens side.

A lens side image stabilization control unit 126 calculates an image blur correction amount for suppressing shake using the image blur correction lens 102, based on a shake detection signal(s) detected by the lens side shake detection unit 125 or the camera side shake detection unit 134, or both of the shake detection units. Then, the lens side image stabilization control unit 126 transmits a drive signal of the image blur correction lens 102 to an image blur correction lens drive unit 122 based on the calculated image blur correction amount and the position of the image blur correction lens 102 that has been detected by an image blur correction lens position detection unit 123, and the lens side image stabilization control unit 126 thereby controls camera shake correction to be executed using the image blur correction lens 102.

The image blur correction lens drive unit 122 is an actuator including a voice coil motor, and drives (displaces) the image blur correction lens 102 in a direction perpendicular to the optical axis based on the drive signal of the image blur correction lens 102 that has been received from the lens side image stabilization control unit 126. A control method of camera shake correction using the image blur correction lens 102 will be described in detail below.

A camera side image stabilization control unit 133 can communicate with the lens side image stabilization control unit 126 via the camera side communication unit 140 and the lens side communication unit 128. The camera side image stabilization control unit 133 calculates an image blur correction amount for suppressing shake using the image sensor 106, based on a shake detection signal(s) detected by the camera side shake detection unit 134 or the lens side shake detection unit 125, or both of the shake detection units. Then, the camera side image stabilization control unit 133 transmits a drive signal of the image sensor 106 to an image sensor drive unit 130 based on the calculated image blur correction amount and the position of the image sensor 106 that has been detected by an image sensor position detection unit 132, and the camera side image stabilization control unit 133 thereby controls camera shake correction to be executed using the image sensor 106.

The image sensor drive unit 130 is an actuator including a voice coil motor or an ultrasonic motor, and drives (displaces) the image sensor 106 in the direction perpendicular to the optical axis based on the drive signal of the image sensor 106 that has been received from the camera side image stabilization control unit 133. A control method of camera shake correction using the image sensor 106 will be described in detail below.

A motion vector detection unit 131 calculates a correlation value of a current frame and a previous frame for each of blocks obtained by dividing a frame, by using a block matching method. After that, the motion vector detection unit 131 searches for a block with the smallest calculation result in the previous frame as a reference block, and detects a shift of another block from the reference block as a motion vector.

A subject detection unit 141 generates subject detection information by detecting an image region of a subject included in a captured image, based on a captured image signal output from the image sensor 106. The subject detection information includes information regarding the position of the subject. In addition to the position of the subject, the subject detection information may include information such as the type of the subject (for example, person/animal/vehicle), a site (for example, pupil/face/body), and a size.

A subject setting unit 143 sets a specific subject in a captured image. By performing a touch or a button operation via the operation unit 114, a photographer can set an arbitrary subject as a tracking target subject from among a plurality of subjects. The tracking target subject can be determined by using an automatic subject setting program of the camera main body 1 without the photographer's operation. In a case where the number of subjects included in a captured image is just one, the subject is set as a tracking target subject.

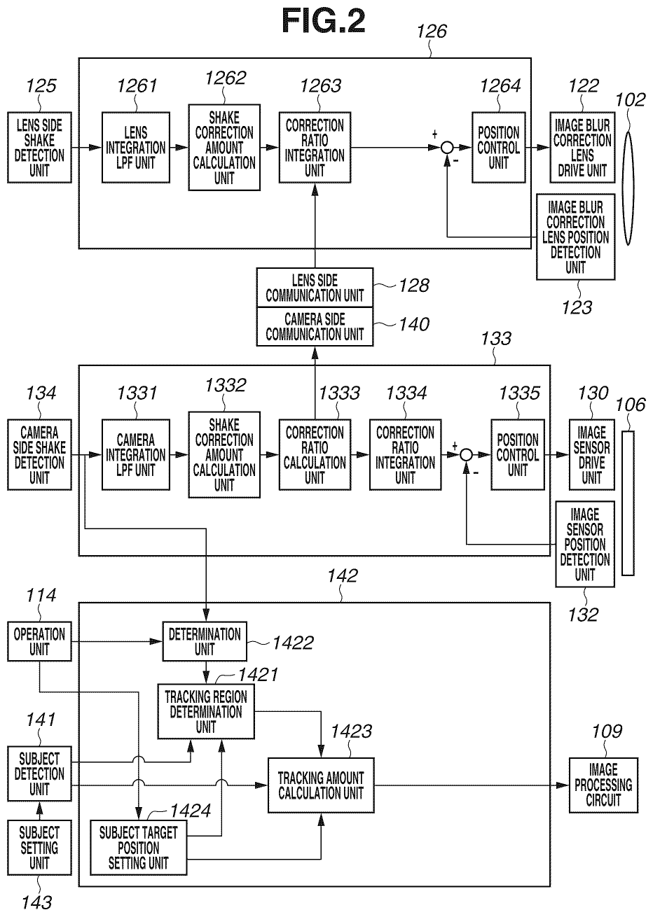

A subject tracking calculation unit 142 calculates a subject tracking amount. The detailed description will be given below with reference to FIG. 2.

FIG. 2 is a block diagram illustrating a configuration example of a mechanism related to image blur correction control and subject tracking control according to the present exemplary embodiment. In the present exemplary embodiment, the camera side image stabilization control unit 133 and the lens side image stabilization control unit 126 perform image blur correction control by controlling the positions of the image sensor 106 and the image blur correction lens 102, respectively. Then, the subject tracking calculation unit 142 performs subject tracking control by controlling the image processing circuit 109.

First of all, a configuration of the camera side image stabilization control unit 133 will be described. As described above, the camera side image stabilization control unit 133 can perform camera shake correction (image blur correction) using the image sensor 106, by driving the image sensor 106.

If the camera side image stabilization control unit 133 acquires, from the camera side shake detection unit 134, a shake angular speed signal detected by the camera side shake detection unit 134, the camera side image stabilization control unit 133 converts the shake angular speed signal into a shake angle signal by performing integration processing using a camera integration low-pass filter (LPF) unit 1331. In this example, an integration low-pass filter (hereinafter, will be referred to as an integration LPF) is used as the camera integration LPF unit 1331.

A shake correction amount calculation unit 1332 calculates a correction amount for cancelling a shake angle, in consideration of a frequency band of a shake angle and a drivable range on the camera side. Specifically, the shake correction amount calculation unit 1332 calculates a shake correction amount by adding gains related to a zoom magnification and a subject distance to the shake angle signal.

A correction ratio calculation unit 1333 calculates a correction ratio accounted for by the camera side when the total of shake correction amounts on the camera side and the lens side is 100%. In the present exemplary embodiment, the correction ratio calculation unit 1333 determines the correction ratio based on the respective movable ranges of the image sensor 106 and the image blur correction lens 102. The correction ratio calculation unit 1333 may determine the correction ratio also considering a movable range in which correction is performed by extracting an image in image processing (electronic camera shake correction), aside from the above-described correction member movable ranges.

A correction ratio integration unit 1334 calculates a camera side image blur correction amount that is based on a correction ratio, by multiplying a shake correction amount by a calculation result obtained by the correction ratio calculation unit 1333.

A position control unit 1335 is a control unit for performing proportional, integral, and differential (PID) control (ratio control, integration control, differential control) on a deviation between a target position of the image sensor 106 that is based on the camera side shake correction amount calculated by the correction ratio integration unit 1334, and a current position of the image sensor 106. The position control unit 1335 converts the deviation between the target position and the current position into an image sensor drive signal, and inputs the image sensor drive signal to the image sensor drive unit 130. The current position is an output result of the image sensor position detection unit 132. Since the PID control is a general technique, the detailed description thereof will be omitted. The image sensor drive unit 130 drives the image sensor 106 in accordance with the image sensor drive signal.

Next, the lens side image stabilization control unit 126 will be described. As described above, the lens side image stabilization control unit 126 can perform camera shake correction using the image blur correction lens 102 (image blur correction), by driving the image blur correction lens 102. If the lens side image stabilization control unit 126 acquires, from the lens side shake detection unit 125, a shake angular speed signal detected by the lens side shake detection unit 125, the lens side image stabilization control unit 126 converts the shake angular speed signal into a shake angle signal by performing integration processing using a lens integration LPF unit 1261. In this example, an integration LPF is used as the lens integration LPF unit 1261.

A shake correction amount calculation unit 1262 calculates a correction amount for cancelling a shake angle, in consideration of a frequency band of the shake angle and a drivable range on the camera side. Specifically, the shake correction amount calculation unit 1332 calculates a shake correction amount on the lens side by adding gains related to a zoom magnification and a subject distance to the shake angle signal.

A correction ratio integration unit 1263 obtains a correction amount that is based on a correction ratio, by multiplying a correction ratio accounted for by the lens side when the total of shake correction amounts on the camera side and the lens side is 100%. In the present exemplary embodiment, the correction ratio accounted for by the lens side is obtained from a calculation result obtained by the correction ratio calculation unit 1333 on the camera side. Correction ratios accounted for by the camera side and the lens side are communicated via the camera side communication unit 140 and the lens side communication unit 128.

A position control unit 1264 is a control unit for performing PID control (ratio control, integration control, differential control) on a deviation between a target position of the image blur correction lens 102 that is based on the lens side shake correction amount calculated by the correction ratio integration unit 1263, and a current position of the image blur correction lens 102. The position control unit 1264 converts the deviation between the target position and the current position into an image blur correction lens drive signal, and inputs the image blur correction lens drive signal to the image blur correction lens drive unit 122. The current position is an output result of the image blur correction lens position detection unit 123. Since the PID control is a general technique, the detailed description thereof will be omitted. The image blur correction lens drive unit 122 drives the image blur correction lens 102 in accordance with the image blur correction lens drive signal.

By driving the image blur correction lens 102 and the image sensor 106 in the above-described manner, it is possible to reduce image blur attributed to camera shake.

In the present exemplary embodiment, the subject tracking calculation unit 142 can change an image extraction position as in the electronic camera shake correction, based on subject detection information acquired from the subject detection unit 141. As described above, the subject setting unit 143 can set an arbitrary subject in a captured image as a tracking target subject (hereinafter, will be sometimes referred to as a main subject). The subject detection unit 141 acquires information such as position information, a size, and a subject type of the main subject set by the subject setting unit 143.

A determination unit 1422 determines an imaging apparatus holding state based on an output signal of the camera side shake detection unit 134. In the present exemplary embodiment, the imaging apparatus holding state refers to a camera work such as a state in which a photographer is capturing an image while walking, a state in which a photographer is capturing an image while performing panning or tilting, or a state in which a photographer is capturing an image while firmly holding an imaging apparatus (ready state). Hereinafter, the state in which a photographer is capturing an image while walking will be sometimes referred to as a walking state. Hereinafter, the state in which a photographer is capturing an image while performing panning or tilting will be sometimes referred to as a panning state. The details of a determination flow will be described below.

A tracking region determination unit 1421 determines, in an image capturing region, a region in which a subject is not to be tracked (hereinafter, will be sometimes referred to as a dead zone) and a region in which a subject is to be tracked (hereinafter, will be sometimes referred to as a tracking region). In the present exemplary embodiment, the tracking region is determined based on a determination result obtained by the determination unit 1422, and a target position set by a subject target position setting unit 1424 to be described below. Alternatively, by setting the dead zone, a remaining region may be set as the tracking region. In contrast, by setting the tracking region, a remaining region (inside of the tracking region when viewed from the target position) may be set as the dead zone. The details of a tracking region determination flow will be described below.

The subject target position setting unit 1424 sets a target position in an image of a main subject set by the subject setting unit 143. In the present exemplary embodiment, a subject target position is assumed to be changeable in accordance with a camera setting. Example of the target position include the center of an image capturing range (recorded image), a position designated by the user, and a prestored coordinate position. In addition, the position of a subject at a timing at which a subject tracking function is set to ON may be determined as a target position. The target position may be designated by the user touching a point on a touch panel that the user desires to set as the target position, when a live view image or a recorded movie is displayed on the touch panel. The subject target position needs not be made changeable, and a target position may be fixed. In this case, the subject target position setting unit 1424 may output the same target position to the tracking region determination unit 1421, or the subject target position setting unit 1424 may be omitted. In the present exemplary embodiment, hereinafter, the center of an image capturing range is set as a subject target position for the sake of simplicity.

A tracking amount calculation unit 1423 calculates a tracking amount in accordance with a subject target position set by the subject target position setting unit 1424, the current position in an image of a main subject that has been detected by the subject detection unit 141, and a tracking region determined by the tracking region determination unit 1421.

The image processing circuit 109 performs image processing using the tracking amount calculated by the tracking amount calculation unit 1423 as an input. In the case of the present exemplary embodiment, the image processing circuit 109 performs geometric transformation processing similar to electronic camera shake correction. Subject tracking processing is performed in this manner, and an image having been subjected to the subject tracking processing is recorded onto the storage memory 113 or displayed on the display unit 111.

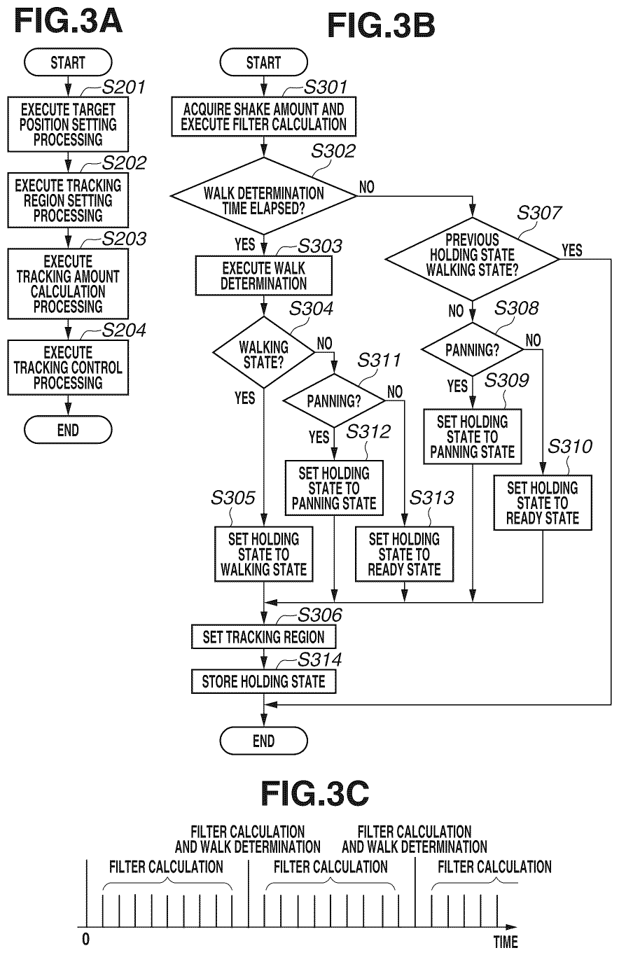

FIGS. 3A and 3B are flowcharts illustrating the subject tracking processing. FIG. 3A is a flowchart illustrating the entire subject tracking processing, and FIG. 3B is a flowchart illustrating processing of determining an imaging apparatus holding state and setting a subject tracking region. These pieces of processing are mainly performed by the subject tracking calculation unit 142. Hereinafter, the flowcharts illustrated in FIGS. 3A and 3B will be described in detail.

A flow of the entire subject tracking processing will be described with reference to FIG. 3A. If the subject tracking processing is started, first of all, in step S201, the imaging apparatus according to the present exemplary embodiment performs the setting of a target position using the subject target position setting unit 1424. In this step, the center of an image capturing range is set as a target position. In a case where a target position is unchangeable, this step is omitted.

Next, in step S202, the imaging apparatus performs the setting of a dead zone and a subject tracking region. In the present exemplary embodiment, as described above, the tracking region determination unit 1421 determines a dead zone and a tracking region based on a holding state of the imaging apparatus and the target position set in step S201. The details of the processing will be described with reference to FIG. 3B.

Next, in step S203, the imaging apparatus performs the calculation of a tracking amount. In the present exemplary embodiment, the tracking amount calculation unit 1423 calculates a tracking amount based on a difference between a subject target position set by the subject target position setting unit 1424 and a current position in an image of a main subject that has been detected by the subject detection unit 141. At this time, in a case where the current position of the main subject is within the dead zone, the tracking amount calculation unit 1423 calculates a fixed value as a tracking amount irrespective of a difference between the target position and the main subject position. For example, in a case where a tracking amount is 0 and the main subject position is within the dead zone, the tracking amount calculation unit 1423 calculates 0 as a tracking amount. In a case where a tracking amount is a predetermined amount and the main subject position is within the dead zone, the tracking amount calculation unit 1423 maintains the tracking amount set at the time.

Next, in step S204, the imaging apparatus performs tracking processing. In the present exemplary embodiment, the tracking amount is output from the tracking amount calculation unit 1423 to the image processing circuit 109, and the image processing circuit 109 performs geometric transform based on this tracking amount, so that the main subject position in a recorded image is brought closer to the target position. By repeatedly performing a series of processes in steps S201 to S204 for each frame, subject tracking processing can be performed. The target position setting processing in step S201 and the dead zone and tracking region setting in step S202 need not be performed for each frame. For example, the target position setting processing in step S201 may be omitted until a target position change operation is input from a photographer. The dead zone and tracking region setting in step S202 may be executed at regular time intervals. For example, in a case where a holding state is a walking state where a photographer is capturing an image while walking and the photographer stops suddenly, it can be considered that there is a time lag between the sudden stop and a timing at which the photographer firmly holds the imaging apparatus. Thus, in one embodiment, the dead zone and tracking region setting in step S202 may be performed only once every several frames. After the end of the tracking region setting processing in step S202 that is performed for the first time, the processing may proceed to step S203. The tracking region setting processing in step S202 for the second and subsequent times may be performed concurrently with the tracking amount calculation in step S203 and the tracking control in step S204. Information regarding the dead zone and the tracking region that are to be used in the tracking amount calculation processing in step S203 may be updated only in a case where a size or a position of the tracking region is changed by the tracking region setting processing.

The processing of determining an imaging apparatus holding state (camera work) and setting a subject tracking region will be described with reference to FIG. 3B. In the present exemplary embodiment, shake added to the imaging apparatus is acquired from the camera side shake detection unit 134, and a holding state is determined based on the acquired shake. These pieces of processing are mainly performed by the determination unit 1422 and the tracking region determination unit 1421.

First of all, in step S301, the determination unit 1422 acquires a detection result from the camera side shake detection unit 134 and performs calculation for filter processing of the detection result.

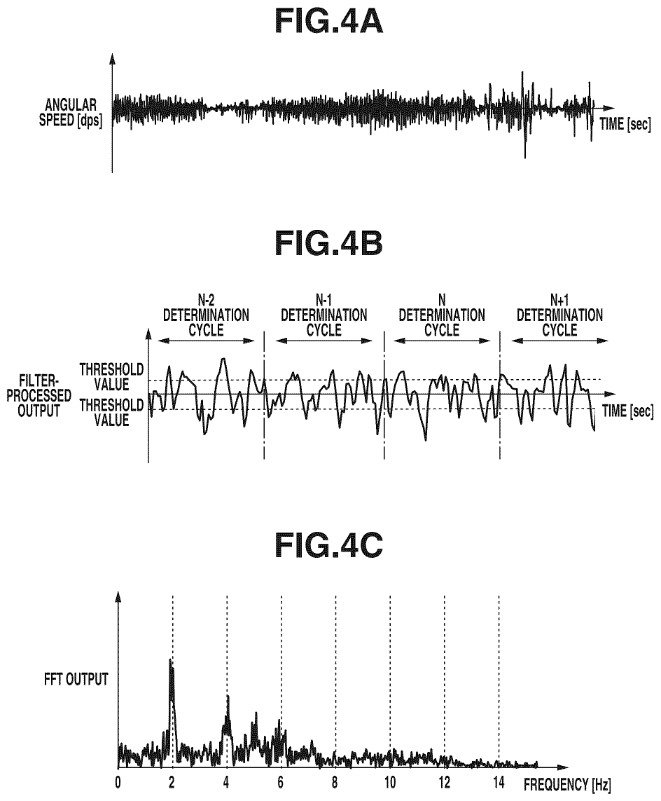

The filter processing performed in step S301 will be described with reference to FIGS. 4A to 4C. FIG. 4A illustrates an angular speed signal output by the camera side shake detection unit 134 when a photographer is in a walking state, and FIG. 4B illustrates a signal obtained by performing filter (high-pass filter: HPF) processing on the angular speed signal illustrated in FIG. 4A. Whether a photographer is walking, i.e., a photographer is in the walking state, can be determined by checking the signal illustrated in FIG. 4B, against a frequency band in the walking state. For example, a threshold value and a predetermined number of times are preset based on a signal obtained by performing the filter processing on the angular speed signal output in the walking state. Then, the number of times that the signal obtained by performing the filter processing on the angular speed signal exceeds the threshold value is counted, and if the counted number of times that the signal exceeds the threshold value is equal to or larger than the predetermined number of times, it can be determined that the photographer is in the walking state. Alternatively, in one embodiment, only the threshold value may be set. In this case, if the signal exceeds the threshold value, it may be determined that the photographer is in the walking state, and if the signal is equal to or smaller than the threshold value, it may be determined that the photographer is not in the walking state. Thus, in step S301, the filter processing is performed.

The determination is performed at a fixed cycle (determination cycle). In a case where the determination cycle is long, the determination of the motion of the photographer is delayed. On the other hand, in a case where the determination cycle is short, the motion of the photographer can be determined with little delay; however, there is a risk of erroneous determination. Thus, a determination cycle is to be appropriately set. The above-described predetermined number of times is set to the number of times suitable for this determination cycle. The timings of filter calculation and determination will be described with reference to FIG. 3C. FIG. 3C illustrates a case where the photographer is determined to be in the walking state based on results of performing filter calculation and comparison with the threshold value ten times.

Whether a photographer is in the walking state may be determined by performing calculation such as frequency analysis in place of the filter processing. FIG. 4C illustrates a graph indicating an output obtained by performing fast Fourier transformation (FFT) analysis on the angular speed signal illustrated in FIG. 4A. In this manner, when a photographer is walking, a peak of a frequency component (especially around 2 Hz to 6 Hz in this example) of shake generated during the walking state becomes large. Accordingly, whether a photographer is in the walking state can also be determined by comparing an output of a frequency band in the walking state in the FFT analysis result of the detected angular speed signal with an arbitrary threshold value.

In the present exemplary embodiment, a method that uses an output of the camera side shake detection unit 134 has been described, but an output of the lens side shake detection unit 125, the motion vector detection unit 131, or another motion sensor may be used.

If the processing in step S301 ends, the processing proceeds to the processing in step S302. In step S302, whether a walk determination time has elapsed is determined. Specifically, since walk determination (i.e., determination of whether a photographer is in the walking state) is periodically performed, whether a determination cycle has elapsed is determined. If the walk determination time has elapsed (YES in step S302), the processing proceeds to step S303. If the walk determination time has not elapsed (NO in step S302), the processing proceeds to step S307.

In step S303, walk determination is performed. As described above, for example, the walk determination is performed by checking the angular speed signal (FIG. 4B) filter-processed in step S301 and counting the number of times that a value of the filter-processed angular speed signal exceeds the predetermined threshold value. If the value of the filter-processed angular speed signal exceeds the predetermined threshold value the predetermined number of times within a walk determination cycle, it is determined that the photographer is in the walking state, and if the counted number of times is equal to or smaller than the predetermined number of times, it is determined that the photographer is in a stopped state. If the processing in step S303 ends, the processing proceeds to the processing in step S304.

In step S304, it is determined whether the walk determination result obtained in step S303 this time indicates the walking state. In a case where the walk determination result obtained in step S303 indicates the walking state (YES in step S304), the processing proceeds to step S305. In step S305, a holding state is set to the “walking state”. On the other hand, in a case where the walk determination result obtained in step S303 indicates the stopped state (it is that the photographer is not in the walking state) (NO in step S304), the processing proceeds to step S311.

In step S311, whether panning is currently performed is determined. Since determination of whether panning is performed (panning determination) can be performed using a known technique, the detailed description thereof will be omitted. The panning determination can also be performed using an output of the camera side shake detection unit 134 or a motion vector. In a case where the photographer is performing panning (YES in step S311), the processing proceeds to step S312. In step S312, a holding state is set to the “panning state”. On the other hand, in a case where it is determined in step S311 that the photographer is currently not performing panning (NO in step S311), the processing proceeds to step S313. In step S313, a holding state is set to the state where the photographer is firmly holding the imaging apparatus (“ready state”).

Next, the description will return to step S307. As described above, in a case where it is determined in step S302 that the walk determination time has not elapsed (NO in step S302), the processing proceeds to step S307. In step S307, referring to a previous determination result stored in step S314, it is determined whether the holding state indicates the walking state. In a case where the previous determination result stored in step S314 indicates the walking state (YES in step S307), this flow ends. In a case where the previous determination result stored in step S314 does not indicate the walking state (NO in step S307), the processing proceeds to step S308.

In step S308, whether panning is currently performed is determined. The determination method in step S308 may be the same as the determination method in step S311, or may be different from the determination method in step S311. As described above, because the panning determination is a known technique, the detailed description thereof will be omitted. In a case where the photographer is performing panning (YES in step S308), the processing proceeds to step S309. In step S309, a holding state is set to the “panning state”. On the other hand, in a case where it is determined in step S311 that the photographer is currently not performing panning (NO in step S308), the processing proceeds to step S310. In step S310, a holding state is set to the “ready state”.

If a holding state is set in the processing in step S305, S312, S313, S309, or S310, the processing proceeds to the processing in step S306.

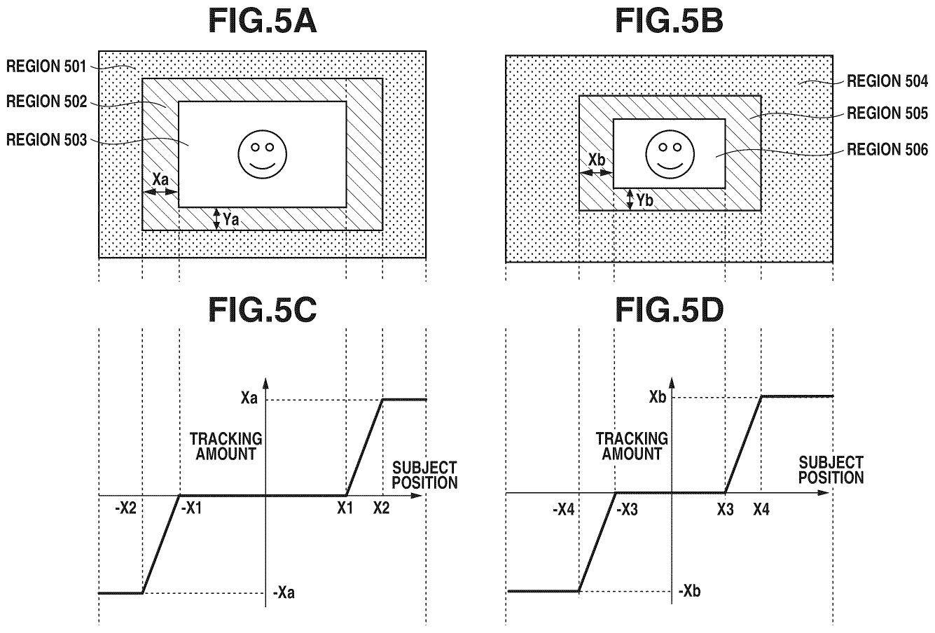

In step S306, the tracking region is set in accordance with a holding state. In the present exemplary embodiment, in a case where the holding state is determined to be the walking state or the panning state, a distance between the tracking region and a target position is shortened by narrowing a dead zone as compared to a case where the holding state is determined to be the ready state (imaging apparatus is firmly held). The processing will be described with reference to FIGS. 5A and 5B.

FIG. 5A illustrates an example of a dead zone and a tracking region that are set in a case where the photographer remains still while holding the imaging apparatus and the holding state is determined to be the “ready state”. FIG. 5B illustrates an example of a dead zone and a tracking region that are set in a case where the photographer is walking while holding the imaging apparatus and the holding state is determined to be the “walking state”, or in a case where the photographer is performing panning or tilting with imaging apparatus and the holding state is determined to be the “panning state”. In FIGS. 5A and 5B, regions 502 and 505 are tracking regions, and regions 503 and 506 are dead zones. In the present exemplary embodiment, because upper limit values of a trackable region do not depend on the holding state, in FIGS. 5A and 5B, a length Xa of the region 502 and a length Xb of the region 505 are equal, and a length Ya of the region 502 and a length Yb of the region 505 are equal. The lengths Xa and Xb indicate an upper limit value of the trackable region in a traverse direction, and the lengths Ya and Yb indicate an upper limit value of the trackable region in a longitudinal direction.

In FIGS. 5A and 5B, regions 501 and 504 are regions exceeding the upper limit values of the trackable regions. In a case where subjects exist in these regions, a subject position in a captured image cannot be matched with a target position. In a case where subjects exist in the regions 501 and 504, tracking may be performed in such a manner as to bring a subject position closer to a target position, but to surely execute tracking when a subject enters a subject tracking region (region 502 or 505), the regions 501 and 504 may be set as dead zones. In the present exemplary embodiment, the description will be given assuming that the regions 501 and 504 are set as dead zones. In a case where a large range can be set as a range that can be used for tracking, i.e., in a case where there are many surplus pixels in a case where tracking is performed by geometric deformation), a region of a peripheral part can be eliminated or narrowed.

FIG. 5C illustrates a tracking amount in the case illustrated in FIG. 5A, and FIG. 5D illustrates a tracking amount in the case illustrated in FIG. 5B.

In the present exemplary embodiment, since a subject target position is set at the center of an image capturing range, dead zones are provided in a center part of the image capturing range and a peripheral part exceeding the upper limit values of a trackable region. The dead zone provided in the center part (first region: region 503 or 506) is a region for preventing subject tracking from being responsively executed.

In a case where a main subject exists in this region, as illustrated in FIGS. 5C and 5D, a tracking amount is set to 0.

A tracking region (second region: region 502 or 505) is provided on the outside of this dead zone. In a case where a main subject exists in this region, as a difference between a target position and a main subject position becomes larger, a tracking amount also becomes larger.

As illustrated in FIG. 5A, when the photographer is in the ready state, a broader size is set as a size of the region 503 as a dead zone near the center that is arranged in such a manner as to include a target position. With this configuration, it is possible to avoid responsively responding to small motion of a tracking target subject. It is possible to avoid consuming a movable range to be used for tracking to respond to small motion (surplus pixels in the width defined by the lengths Xa and Ya in the case of the present exemplary embodiment). On the other hand, by setting the region 502 as a tracking region at a position on the outside of the region 503 that is distant from the target position, subject tracking can be executed on large motion that can cause the tracking target subject to go out of the frame.

In contrast to this, when the photographer is walking or performing panning, as illustrated in FIG. 5B, a smaller size is set as a size of the region 506 as a dead zone near the center that is arranged in such a manner as to include a target position. With this configuration, the region 505 as a tracking region is set closely to the target position, and subject tracking is executed from the vicinity of the target position. When the photographer is walking, the photographer cannot concentrate on framing. In such a case, subject tracking is controlled to be performed from the vicinity of the target position in the foregoing manner so as to stably bring a subject image into the image capturing range. Especially when the photographer is performing panning, it is difficult to stably retain a subject at the same position within the image capturing range. This is because a difference is easily generated between a motion speed of an image capturing target and a panning speed of the photographer. In the present exemplary embodiment, in a case where the photographer is in the panning state, subject tracking is performed with a smaller dead zone than in a case where the photographer is in the ready state, so that a shift in subject position that is generated due to the difference in speed can be corrected. This stabilizes a subject image.

In the present exemplary embodiment, the ready state, the walking state, and the panning state have been described as holding states, but the holding states are not limited to these. The present exemplary embodiment is effective also for a case where the imaging apparatus is held using a gimbal stabilizer, for example. Because the gimbal stabilizer corrects all angular speed components added to the imaging apparatus, even if a photographer tries to execute framing by performing panning or tilting in synchronization with the motion of a subject, the panning or the tilting is not reflected, and framing is difficult. To solve this issue, when the attachment of the gimbal stabilizer is detected, as illustrated in FIG. 5B, a smaller dead zone is set than in a case where the gimbal stabilizer is not detected, so as to bringing the tracking region closer to the subject target position, so that it becomes possible to stably execute framing even though there is motion in a subject image. In this case, because shake (handshake) added to the imaging apparatus is basically corrected by the gimbal stabilizer, the imaging apparatus may use the entire camera shake correction mechanism for subject tracking. The attachment of the gimbal stabilizer (gimbal mode determination) may be determined based on a detection result obtained by a shake detection unit (the camera side shake detection unit 134) included in the imaging apparatus, or may be set by a photographer via the operation unit 114. In a case where the attachment of the gimbal stabilizer is determined based on a detection result obtained by the shake detection unit and a state in which a shake signal has a value smaller than a predetermined value continues for a predetermined time or more (in a case where a state in which shake is hardly added continues), the gimbal stabilizer can be determined to be attached to the imaging apparatus. In addition, an attached state of the gimbal stabilizer can also be determined by using an acceleration sensor in addition to an angular speed sensor of the shake detection unit, and monitoring outputs of the both sensors. For example, when a photographer captures an image while walking with the gimbal stabilizer being attached to the imaging apparatus, while an angular speed output becomes smaller, a predetermined amount of an acceleration output is generated. Utilizing this feature, an attached state of the gimbal stabilizer can be detected.

If a tracking region is set in step S306, the processing proceeds to step S314. In step S314, a determination result obtained this time is stored in such a manner that the holding state can be referred to in the processing in step S307 that is to be performed next time, and this flow ends.

As in the present exemplary embodiment, by determining an imaging apparatus holding state using the shake detection unit, and setting the position of a subject tracking region based on the determination result, it is possible to reduce unnaturalness in a movie, which is attributed to a delay time during the process of tracking amount calculation, and is likely to stand out especially when a photographer is in the ready state.

Furthermore, when a photographer is walking or performing panning and a subject position easily deviates from a target position, it is possible to effectively perform subject tracking. It is accordingly possible to provide an imaging apparatus with good subject tracking performance that enables the subject to look natural.

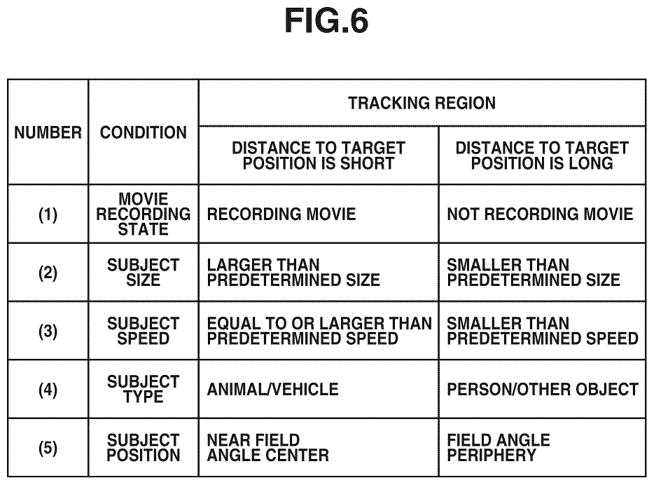

In a second present exemplary embodiment, the description will be given of a configuration of detecting an operation performed by a photographer on an imaging apparatus and changing a subject tracking region in accordance with the operation. The present exemplary embodiment corresponds to Number (1) in the table illustrated in FIG. 6.

Hereinafter, an imaging apparatus according to the present exemplary embodiment will be described.

Because the configuration of the imaging apparatus according to the present exemplary embodiment is similar to the configuration in the first exemplary embodiment that has been described with reference to FIGS. 1 and 2, the detailed description thereof will be omitted, and a point different from the first exemplary embodiment will be described. Also in the present exemplary embodiment, the center of an image capturing range is assumed to be set as a subject target position for the sake of simplicity.

In the present exemplary embodiment, the determination unit 1422 functions as an operation detection unit that acquires a signal indicating an operation of a photographer that is performed by the photographer via the operation unit 114 and determines the content of the operation. Then, the tracking region determination unit 1421 determines a subject tracking region based on a determination result obtained by the determination unit 1422.

Examples of operations to be performed by a photographer via the operation unit 114 include an operation of requesting to start movie recording (the press of a movie recording start button, etc.) and an operation of requesting to stop movie recording (the re-press of the movie recording start button, etc.). Before the operation of requesting to start movie recording is input, as illustrated in FIG. 5A, a large-sized dead zone (first region) is set and a tracking region (second region) is set at a position distant from a subject target position. If the determination unit 1422 determines that the input of the operation of requesting to start movie recording has been received, the determination result is input to the tracking region determination unit 1421, and as illustrated in FIG. 5B, the tracking region determination unit 1421 that has received the input of the determination result brings the tracking region closer to the subject target position than the tracking region illustrated in FIG. 5A. If the determination unit 1422 determines that the input of the operation of requesting to stop movie recording has been received, the determination result is input to the tracking region determination unit 1421, and the tracking region determination unit 1421 that has received the input of the determination result returns the positions of the dead zone and the subject tracking region to the state illustrated in FIG. 5A. In this manner, by setting a subject tracking region based on the operations of requesting to start and stop movie recording, it is possible to save a usage rate of a movable range usable for subject tracking so that a photographer can focus on framing before starting movie recording. That is, it is possible to reduce a probability that a movable range usable for subject tracking runs out before movie recording.

In the present exemplary embodiment, the description has been given of the configuration of changing a subject tracking region based on the operations of requesting to start and stop movie recording, however, the tracking region may be changed based on an operation other than these operations. For example, in a case where live broadcasting or live streaming is performed using an imaging apparatus, if an operation of starting broadcasting or streaming is received, the dead zone may be made smaller than the dead zone set in a case where the imaging apparatus is in a standby state, and a tracking region may be brought closer to the target position. In this case, the tracking region is changed based on operations of requesting to start and stop broadcasting or streaming. In a case where live broadcasting or live streaming of a movie is performed using a plurality of imaging apparatuses and an imaging apparatus is designated as an imaging apparatus that captures images to be broadcast or distributed on streaming, a smaller dead zone may be set than in a case where the imaging apparatus is designated as an imaging apparatus in the standby state. In this case, it is sufficient that the tracking region is set based on a switching operation of an imaging apparatus.

Moreover, the tracking region may be changed depending on whether a focus setting is manual focus or autofocus. When a focus setting is manual focus, erroneous tracking is prevented by broadening a dead zone because an image may be out of focus due to the motion of a subject and the accuracy of subject detection information might accordingly decline. On the other hand, in a case where a focus setting is an autofocus setting, a subject can be brought into focus and the accuracy of subject detection information is high. Accordingly, the dead zone is set smaller than the dead zone set in the manual focus setting, a trackable range is broadened. In a case where a mode for performing processing of trimming an image in a movie is set, for example, the dead zone may be reduced in size and the tracking region may be brought close to the target position. This is because the subject might go out of a frame due to the trimming.

The tracking region determination unit 1421 may determine a tracking region based on a holding state as in the first exemplary embodiment, and further determine a tracking region based on an operation performed by a photographer. For example, in a case where a holding state is the walking state or the panning state and an imaging apparatus is not in a movie recording state, a larger dead zone may be set than in a case where a holding state is a firmly-held state (ready state) or in a case where a holding state is the walking state or the panning state and an imaging apparatus is in the movie recording state. In a case where a holding state is the walking state or the panning state and an imaging apparatus is not in the movie recording state, a large dead zone may be set. In a case where a holding state is the firmly-held state (ready state), a small dead zone may be set. In a case where a holding state is the walking state or the panning state and an imaging apparatus is in the movie recording state, a size of a dead zone may be set to an intermediate size between the large dead zone and the small dead zone.

In a third present exemplary embodiment, the description will be given of a configuration of setting a tracking region based on subject information obtained by subject detection. The present exemplary embodiment corresponds to Numbers (2), (3), and (4) in the table illustrated in FIG. 6.

Hereinafter, an imaging apparatus according to the present exemplary embodiment will be described.

Because the configuration of the imaging apparatus according to the present exemplary embodiment is similar to the configuration in the first exemplary embodiment that has been described with reference to FIGS. 1 and 2, the detailed description thereof will be omitted, and a point different from the first exemplary embodiment will be described. Also in the present exemplary embodiment, the center of an image capturing range is assumed to be set as a subject target position for the sake of simplicity.

In the present exemplary embodiment, the tracking region determination unit 1421 acquires subject information of a detected main subject from the subject detection unit 141, and determines a tracking region based on the subject information. Examples of the subject information include a size of a face of the main subject, a moving speed of the main subject, and a subject type of the main subject (for example, information indicating whether the main subject is a person or an object other than a person).

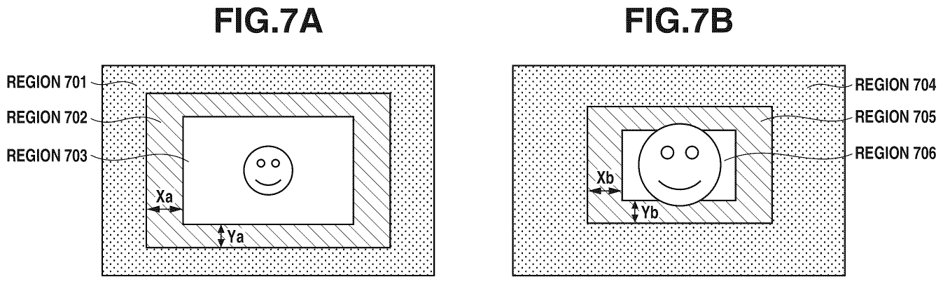

An example of determining a tracking region based on a size of a main subject will be described. FIGS. 7A and 7B are image diagrams illustrating a size of a main subject and a tracking region. Regions 702 and 705 are tracking regions (second regions), and regions 703 and 706 are dead zones (first regions). Regions 701 and 704 are regions exceeding the upper limit values of trackable regions, and are dead zones similarly to the first exemplary embodiment. FIG. 7A illustrates a case where a size of a main subject is smaller than a predetermined size, and FIG. 7B illustrates a case where a size of a main subject is equal to or larger than the predetermined size.

In a case where a size of a region of a subject to be tracked is small as illustrated in FIG. 7A, because the motion of the main subject appears small in an image (recorded image during recording or a displayed image during live view), it is considered that the main subject is unlikely to go out of a frame and a photographer can easily execute framing. Thus, the framing by the photographer is mainly executed, and the subject tracking is executed when the main subject is about to go out of a frame, without tracking fine motion of the main subject. Accordingly, the large-sized region 703 as a dead zone is set around the center of an image corresponding to a target position, and the region 702 as a tracking region is arranged at a position distant from the target position.

On the other hand, in a case where a size of a region of a subject to be tracked is large as illustrated in FIG. 7B, because the motion of the main subject appears large in an image, it is considered that, even if a photographer is executing framing, the main subject is highly likely to go out of a frame. Thus, by making the region 706 as a dead zone around the center of the image corresponding to a target position, smaller than the region 703, and arranging the region 705 as a tracking region, closer to the target position than the region 702, subject tracking is executed responsively to the motion of the main subject that can cause the main subject to go out of a frame.

A moving speed may be calculated from an amount of change in position information of the main subject, and a tracking region may be determined based on the moving speed. It is easily predictable that, if a moving speed of a subject is large, the subject is highly likely to go out of a frame. Thus, when the moving speed of the main subject is smaller than a predetermined speed, as illustrated in FIG. 7A, a large dead zone is set around the center of the image corresponding to a target position, and when the moving speed of the main subject is equal to or larger than the predetermined speed, a small dead zone is set.

The case of determining a tracking region based on the type of a main subject will be described. For example, a tracking region is determined based on information indicating whether the main subject is a person, an animal, or another object. In particular, since an animal is assumed to move at a fast speed and make unexpected motions, it can be difficult for a photographer to quickly respond to and catch up with the motions of the animal, and the main subject is highly likely to go out of a frame. Thus, as illustrated in FIG. 7B, a small dead zone is set around the center of the image corresponding to a target position, and subject tracking is executed responsively to the motions of a tracking target. In a case where a vehicle is identifiable, because a vehicle generally moves at fast speed, it is considered that a photographer may not quickly respond to and catch up with the motion of the vehicle and the vehicle is highly likely to go out of a frame. Thus, a small dead zone is set similarly. A tracking region determination method that is based on the type of a subject is not limited to this. For example, assuming that a photographer can execute framing rather easily on a vehicle because a vehicle goes on a predetermined route, a large dead zone may be set as illustrated in FIG. 7A. In addition, in a case where the type of the vehicle (train, car, airplane, etc.) can be determined, a large dead zone may be set for a vehicle such as a train or an airplane of which the route is predetermined, and a dead zone smaller than the dead zone for trains and airplanes may be set for a vehicle such as a car and a motorbike of which the route is likely to be undetermined. Alternatively, in combination with an individual authentication function, a tracking region may be determined based on whether a tracking target is a child or an adult. For example, assuming that children make unexpected motions as compared with adults, in a case where a tracking target subject is a child, a smaller dead zone may be set than in a case where a tracking target subject is an adult. Alternatively, in one embodiment, only information indicating whether a subject is a person or an object other than a person may be acquired as the type of the subject, and in a case where a main subject is a person, a larger dead zone may be set and a tracking region may be set at a farther position than in a case where a main subject is an object other than a person.

As described above, by determining a tracking region in accordance with subject information acquired from the subject detection unit 141, it is possible to reduce a probability that a main subject goes out of a frame, and provide a moving image in which a subject image is stable.

In the present exemplary embodiment, the description has been given of the configuration of changing a tracking region based on a subject size, a subject speed, and a subject type; however, a tracking region may be determined based on another type of subject information.

In a fourth exemplary embodiment, the description will be given of a configuration of determining a tracking region in accordance with a target position. The present exemplary embodiment corresponds to Number (5) in the table illustrated in FIG. 6.

Hereinafter, an imaging apparatus according to the present exemplary embodiment will be described.

Because the configuration of the imaging apparatus according to the present exemplary embodiment is similar to the configuration in the first exemplary embodiment that has been described with reference to FIGS. 1 and 2, the detailed description thereof will be omitted, and a point different from the first exemplary embodiment will be described. In the present exemplary embodiment, an arbitrary coordinate designated by a photographer is set as a target position, and subject tracking control is performed based on the target position. The photographer preliminarily sets an arbitrary coordinate via the operation unit 114. The subject tracking calculation unit 142 transmits the coordinate designated by the photographer, to the subject target position setting unit 1424, and the subject target position setting unit 1424 sets the coordinate as a target position.

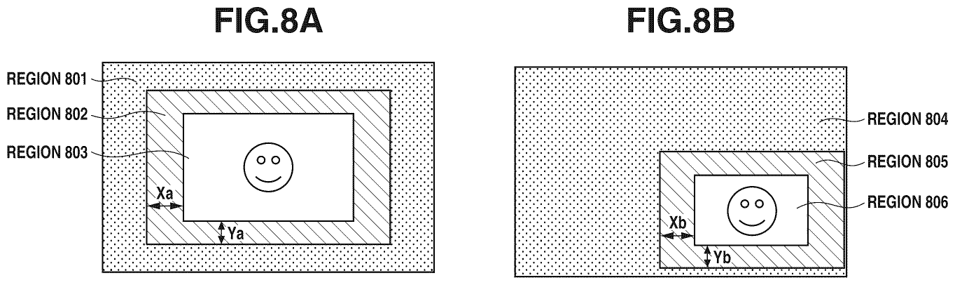

The tracking region determination unit 1421 determines a tracking region based on the target position set by the subject target position setting unit 1424. The processing will be described with reference to FIGS. 8A and 8B.

FIGS. 8A and 8B are diagrams illustrating an example of relationship between a target position and a tracking region. Regions 802 and 805 are tracking regions (second regions), and regions 803 and regions 806 are dead zones (first regions).

Regions 801 and 804 are regions exceeding the upper limit values of trackable regions. FIG. 8A illustrates a tracking region determined in a case where a target position is set at the center of an image. In contrast to this, FIG. 8B illustrates a tracking region determined in a case where a target position is set at a position distant from the center of an image.

In the present exemplary embodiment, as a target position of a main subject becomes more distant from the center of an image (i.e., as an image height at a target position becomes higher), a dead zone is made smaller, and a distance from the target position to the tracking region is made shorter. This is because, when a subject moves at a predetermined speed, the difficulty of framing is higher in a case where a subject existing at a corner of an image moves than in a case where a subject existing at the center of an image moves. In a case where a subject exists at a corner of an image and is highly likely to go out of a frame, subject tracking is performed with higher responsiveness to the motion of the subject than in other cases, so that it assists the photographer in performing framing. With this configuration, it is possible to reduce a probability that a tracking target subject goes out of a frame out, and provide a moving image in which a tracking target subject image is stable. Instead of narrowing a dead zone as a target position of a main subject becomes more distant from the center of an image, a configuration of narrowing a dead zone if a distance between a target position of a main subject and the center of an image exceeds a threshold value may be employed. A plurality of threshold values may be set. In one embodiment, a size of a dead zone is simply decreased as an image height at a target position becomes larger, but a decrease in size may be continuous or discontinuous.

In this manner, in the first, third, and fourth exemplary embodiments, under an image capturing condition where the difficulty of framing is assumed to be high, a dead zone (first region) is made smaller and a tracking region (second region) is set closer to a target position than under a an image capturing condition where the difficulty of framing is not assumed to be high. A state in which a tracking region is close to a target position refers to a state in which a distance between the tracking region and the target position is short.

Heretofore, exemplary embodiments of the disclosure have been described, although the disclosure is not limited to these exemplary embodiments, and various modifications and changes can be made without departing from the gist thereof.

### Modified Example

In the first to fourth exemplary embodiments, the interchangeable-lens imaging apparatus has been described; however, each exemplary embodiment can also be applied to a lens-integrated imaging apparatus, and can also be applied to an apparatus such as a smartphone that has various functions in addition to an image capturing function.

In the first to fourth exemplary embodiments, the description has been given of the configuration in which the lens apparatus 2 and the camera main body 1 each include an optical camera shake correction mechanism, and the camera main body 1 further includes an electronic camera shake correction mechanism. However, the configuration is not limited to this. It is sufficient that any one or more correction mechanisms of a lens side optical camera shake correction mechanism, a camera side optical camera shake correction mechanism, and a camera side electronic camera shake correction mechanism are included. In a case where two correction mechanisms are included, a combination of the correction mechanisms is not specifically limited.

For example, in a case where neither the lens apparatus 2 nor the camera main body 1 includes an optical camera shake correction mechanism, and camera shake correction and subject tracking are performed by an electronic camera shake correction mechanism, an image capturing range may be moved based on a value obtained by adding outputs of the shake correction amount calculation unit 1332 and the tracking amount calculation unit 1423. At this time, a targeted frequency may vary between a camera shake correction amount that is an output of the shake correction amount calculation unit 1332 and a subject tracking amount that is an output of the tracking amount calculation unit 1423. For example, a shake correction amount calculated based on a shake signal with a predetermined frequency or more, among detected shake amounts, and a tracking amount calculated based on a signal with a frequency smaller than the predetermined frequency, among differences from the target position may be added, and the electronic camera shake correction mechanism may be controlled based on the obtained result.

The camera shake correction mechanism for moving an image capturing range for subject tracking is not limited to the electronic camera shake correction mechanism, and an image capturing range may be moved by a lens side or camera side optical camera shake correction mechanism or may be moved by a plurality of camera shake correction mechanisms.

In the first to fourth exemplary embodiments, the configuration in which camera shake correction and subject tracking are performed has been described, but a configuration of performing subject tracking without performing camera shake correction may be employed.

In the first to fourth exemplary embodiments, an imaging apparatus performs a series of subject tracking processes including the setting of a subject tracking region, the calculation of a tracking amount, and subject tracking control executed by outputting a tracking amount to a camera shake correction mechanism (the image processing circuit 109), but the disclosure is not limited to this. For example, the series of subject tracking control processes may be performed by a control apparatus of an imaging apparatus that controls the imaging apparatus from the outside, or the subject tracking processing may be performed by the imaging apparatus and the control apparatus or a plurality of control apparatuses in a shared manner. The control apparatus may be a cloud, and the imaging apparatus may be controlled from the cloud. In a case where the control apparatus performs the series of subject tracking control processes, the control apparatus may acquire a captured image from the imaging apparatus and perform subject detection to acquire subject information, or the imaging apparatus may acquire subject information from acquiring a result of subject detection performed by the imaging apparatus.

In the first to fourth exemplary embodiments, subject tracking is assumed to be performed in real time, but subject tracking may be executed by performing image processing (crop position change, etc.) on a movie that has been already captured and primarily recorded.

In the first to fourth exemplary embodiments, moving image capturing has been described, but a similar effect can be obtained for continuous image capturing of live view images or still images. In the case of live view images, a range of an image to be displayed as a live view image can be regarded as an image capturing range described in the above-described exemplary embodiments.

In the first to fourth exemplary embodiments, the tracking region determination unit 1421 sets a dead zone (first region) and a tracking region (second region). Alternatively, a region of which a degree to which subject tracking is performed is low may be set as a first region in place of a dead zone. The degree to which subject tracking is performed indicates the extent to which a position of a subject is brought close to a target position when a difference between the target position and a current position of the subject is assumed to be 1. In the dead zone, this degree is 0. If a degree to which subject tracking is performed in the first region is lower than a degree to which subject tracking is performed in the second region, an effect similar to those in the above-described exemplary embodiments can be obtained.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-187569, filed Nov. 24, 2022, which is hereby incorporated by reference herein in its entirety.

What is claimed is:

1. An apparatus comprising:
one or more processors; and
a memory coupled to the one or more processors storing instructions that, when executed by the one or more processors, cause the one or more processors function as:
an acquisition unit configured to acquire information about a subject detected from a captured image;
a calculation unit configured to calculate a tracking amount based on a position of the subject in the captured image and a target position;
a control unit configured to control subject tracking to bring the position of the subject in the captured image close to the target position, based on the tracking amount; and
a setting unit configured to set a first region and a second region based on at least any of a holding state of an imaging apparatus that captures the captured image, a detection result of an operation performed by a photographer on the imaging apparatus, a position in the captured image of the target position, and a type of the subject,
wherein, in the first region, a degree to which the subject tracking is performed is lower than in the second region.

2. The apparatus according to claim 1, wherein, if a size of the first region is changed, a position of the second region is changed.

3. The apparatus according to claim 1, wherein the setting unit sets the first region and the second region based on the holding state of the imaging apparatus.

4. The apparatus according to claim 3,
wherein one or more processors further function as:
a determination unit configured to determine a camera work of the photographer based on a detection result obtained by a detection unit configured to detect motion added to the imaging apparatus, and
wherein the holding state is a determination result of the camera work.

5. The apparatus according to claim 1,
wherein the holding state is determined based on a detection result obtained by a detection unit configured to detect motion added to the imaging apparatus, and
wherein, in a case where a magnitude of shake detected by the detection unit exceeds a threshold value, the setting unit makes a size of the first region smaller than in a case where the magnitude is equal to or smaller than the threshold value.

6. The apparatus according to claim 5,
wherein the holding state is determined based on the detection result obtained by the detection unit configured to detect motion added to the imaging apparatus, and
wherein, in a case where a number of times that the magnitude of shake detected by the detection unit exceeds the threshold value is equal to or smaller than a predetermined number of times, the setting unit sets the second region at a position more distant from the target position than in a case where the number of times that the magnitude exceeds the threshold value is larger than the predetermined number of times.

7. The apparatus according to claim 5,
wherein the holding state is determined based on the detection result obtained by the detection unit configured to detect motion added to the imaging apparatus, and
wherein, in a case where a number of times that the magnitude of shake detected by the detection unit exceeds the threshold value is equal to or smaller than a predetermined number of times, the setting unit sets the first region with a larger size than in a case where the number of times that the magnitude exceeds the threshold value is larger than the predetermined number of times.

8. The apparatus according to claim 3,
wherein the holding state is a determination result indicating whether a gimbal is attached to the imaging apparatus, and
wherein, in a case where the determination result indicates that the gimbal is attached to the imaging apparatus, the setting unit sets the second region at a position closer to the target position than in a case where the determination result indicates that the gimbal is not attached to the imaging apparatus.

9. The apparatus according to claim 3,
wherein the holding state is a determination result indicating whether a gimbal is attached to the imaging apparatus, and
wherein, in a case where the determination result indicates that the gimbal is attached to the imaging apparatus, the setting unit sets the first region with a smaller size than in a case where the determination result indicates that the gimbal is not attached to the imaging apparatus.

10. The apparatus according to claim 1, wherein the setting unit sets the first region and the second region based on the detection result of the operation performed by the photographer on the imaging apparatus.

11. The apparatus according to claim 10,
wherein an operation detection unit detects an operation of starting movie recording and an operation of ending movie recording that are performed by the photographer on the imaging apparatus, and
wherein, during movie recording, the setting unit sets the second region at a position closer to the target position than in a case where a movie is not being recorded.

12. The apparatus according to claim 1, wherein the setting unit sets the first region and the second region based on a distance between the target position and a center of the captured image.

13. The apparatus according to claim 12, wherein, in a case where the distance is a second value larger than a first value, the setting unit sets the second region at a position closer to the target position than in a case where the distance is the first value.

14. The apparatus according to claim 1, wherein the setting unit sets the first region and the second region based on the type of the subject.

15. The apparatus according to claim 14, wherein, in a case where the type of the subject is a person, the setting unit sets the second region at a position more distant from the target position than in a case where the type of the subject is an object other than a person.

16. The apparatus according to claim 1, wherein the first region is a dead zone of the subject tracking.

17. The apparatus according to claim 1, wherein the first region is set closer to the target position than the second region.

18. The apparatus according to claim 17, wherein the first region is set on an inside of the second region.

19. An imaging apparatus comprising:
the apparatus according to claim 1,
a sensor configured to capture the captured image; and
a tracking unit configured to perform subject tracking to bring the position of the subject in the captured image to the target position, according to control executed by the control unit.

20. A method comprising:
acquiring information about a subject detected from a captured image;
calculating a tracking amount based on a position of the subject in the captured image and a target position;
controlling subject tracking to bring the position of the subject in the captured image close to the target position, based on the tracking amount; and
setting a first region and a second region based on at least any of a holding state of an imaging apparatus that captures the captured image, a detection result of an operation performed by a photographer on the imaging apparatus, a position in the captured image of the target position, and a type of the subject,
wherein, in the first region, a degree to which the subject tracking is performed is lower than in the second region.
